(19) United States
(12) Patent Application Publication
(10) Pub. No.: US 2011/0021341 A1
(43) Pub. Date: Jan. 27, 2011

(54) Adsorbents for Organosulfur Compound Removal from Fluids

(75) Inventors: Adam J. Matzger, Ann Arbor, MI (US); Antek G. Wong-Foy, Ann Arbor, MI (US); Katie Cychosz, Stevens Point, WI (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: THE REGENTS OF THE UNIVERSITY OF MICHIGAN, Ann Arbor, MI (US)

(21) Appl. No.: 12/681,175

(22) PCT Filed: Oct. 2, 2008
(86) PCT No.: PCT/US2008/078613

§ 371 Date: Sep. 16, 2010

Related U.S. Application Data
(60) Provisional application No. 60/976,967, filed on Oct. 2, 2007.

(51) Int. Cl. C10G 29/20; C10G 29/00; B01J 20/34

(52) U.S. Cl. 502/22; 208/237; 208/236; 208/230; 208/240; 502/20; 502/34

(57) ABSTRACT

A method for separating organosulfur compounds from a liquid is provided. The method of this embodiment comprises contacting the liquid with the microporous coordination polymer to form a MCP-organosulfur inclusion compound.

### CROSS-REFERENCE TO RELATED APPLICATIONS

This application claims the benefit of U.S. provisional application Ser. No. 60/976,967 filed Oct. 2, 2007, which is incorporated by reference herein.

### BACKGROUND OF THE INVENTION

1. Field of the Invention

In at least one embodiment, the present invention relates to methods of removing organosulfur compounds from liquids.

2. Background Art

Microporous coordination polymers (MCPs) are extended crystalline networks of a metal or of metal clusters linked by organic molecules (FIG. 1). MCPs are porous materials with a rigid, well-defined structure. Many alternative names for these materials have appeared in the literature including metal organic framework (MOF), hybrid inorganic-organic material, open-framework metal carboxylate, and hybrid porous solid, as well as names which refer to the location where the material was originally synthesized such as Hong Kong University of Science and Technology (HKUST) and Matériaux de l'Institut Lavoisier (MIL). By changing the metal or the organic linker, pore size, shape, and functionality can be altered. MCPs have potential application in areas such as gas sorption, separations, catalysis, and large molecule storage and transport.

Conventional diesel fuel contains up to 500 parts per million by weight (ppmw) sulfur. As organosulfur compounds burn, they produce SO₂, which is a major contributor to acid rain. More importantly, catalysts are necessary to reduce NOₓ emissions from fuels. These catalysts are poisoned by the SO₂ gas that results from combustion of fuel. The Department of Transportation has mandated that starting in 2006 and by 2010 a reduction in the concentration of sulfur in diesel from 500 ppmw to 15 ppmw must be achieved.

The removal of sulfur from fuels is also important because onboard reforming of fuels to hydrogen in hydrogen fuel cell vehicles can be achieved by the use of metal catalysts. However, such catalysts are poisoned by levels of sulfur >0.1 ppm. A new scientific approach that is more energy efficient and practical than present techniques to remove organosulfur compounds from fuels would be highly advantageous.

Currently, the most common way to remove organosulfur compounds from fuel is a technique called hydrodesulfurization (HDS). In this technique, a catalyst, typically molybdenum sulfide promoted by cobalt or nickel, is used to hydrogenate and break apart the undesirable compound. The resulting hydrogen sulfide is easier to remove than the original sulfur-containing compound.

Although HDS effectively removes alkyl sulfides and small aromatic organosulfur compounds from fuels, this technique is not efficient at removing larger aromatic organosulfur compounds such as dibenzothiophene and 4,6-dimethyldibenzothiophene because they are fairly unreactive (FIG. 2). Unfortunately, diesel is rich in large organosulfur compounds, motivating the development of alternative removal strategies.

Accordingly, there is a need for improved methods of removing sulfur-containing compounds from a liquid, and in particular for removing relatively large organosulfur compounds.

### SUMMARY OF THE INVENTION

The present invention solves one or more problems of the prior art by providing in one embodiment, a method for separating organosulfur compounds from a liquid. The method of this embodiment comprises contacting the liquid with the microporous coordination polymer to form a MCP-organosulfur inclusion compound.

In another embodiment, a sorbent bed adapted to remove sulfur-containing compounds from a liquid is provided. The sorbent bed includes a microporous coordination polymer as set forth above.

### BRIEF DESCRIPTION OF THE DRAWINGS

FIG. 1 provides examples of microporous coordination polymers (MCPs) (a) MOF-5: Zn₄O metal clusters linked by 1,4-benzenedicarboxylate (Li, H.; Eddaoudi, M.; O'Keeffe, M.; Yaghi, O. M. “Design and synthesis of an exceptionally stable and highly porous metal-organic framework” Nature, 1999, 402, 276-279) (b) HKUST-1: Cu metal clusters linked by 1,3,5-benzenetricarboxylate (Chui, S. S.-Y.; Lo, S. M.-F.; Charmant, J. P. H.; Orpen, A. G.; Williams, I. D. “A Chemically Functionalizable Nanoporous Material [Cu₃(TMA)₂(H₂O)₃]ₙ” Science, 1999, 283, 1148-1150.) MCPs contain large amounts of open space where molecules of the right size and shape can move in and out.

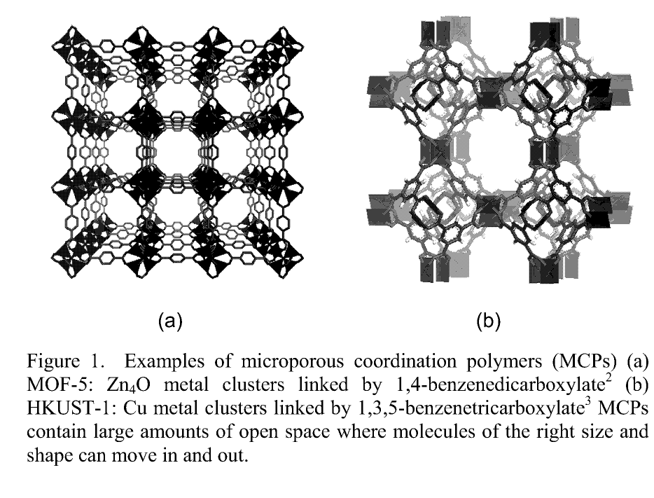

FIG. 2 is a chart of the reactivity of various organosulfur compounds in HDS versus their size and substituents. The larger organosulfur compounds, which are primarily found in diesel fuel, are more difficult to remove using the HDS process (Song, C. “An overview of new approaches to deep desulfurization for ultra-clean gasoline, diesel fuel and jet fuel” Catalysis Today, 2003, 86, 211-263.);

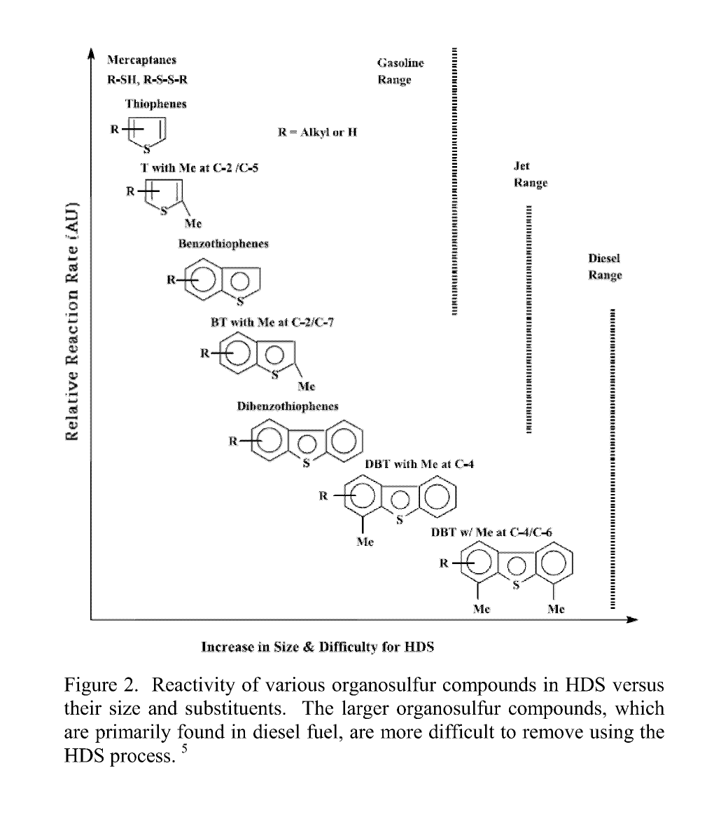

FIG. 3 is a schematic of a sorbent bed that is useful for removing sulfur-containing compounds from a fluid;

FIG. 4A provides examples of MCP structures that are useful in embodiments of the present invention (a) MOF-5(b) MOF-177 (c) HKUST-1 (d) MOF-505 (e) UMCM-150;

FIG. 4B provides examples of linking moieties used in an embodiment of the invention (a) carboxylate (b) thiocarboxylate (c) dithiocarboxylate (d) imidate (e) phosphonate (f) guanidate (g) β-diketonate (h) β-dithionate;

FIGS. 4C-4D provide examples organic spacers used in an embodiment of the invention;

FIG. 5 provides examples of target organosulfur compounds (a) benzothiophene (b) dibenzothiophene (c) 4,6-dimethyldibenzothiophene;

FIG. 6 provides dibenzothiophene adsorption isotherms from 0 to 2000 ppmw S for MOF-177, MOF-5, MOF-505, HKUST-1, and UMCM-150;

FIG. 7 provides 4,6-dimethyldibenzothiophene adsorption isotherms from 0 to 700 ppmw S for MOF-177, MOF-5, MOF-505, HKUST-1, and UMCM-150;

FIG. 8 provides breakthrough curves for 300 ppmw S dibenzothiophene in isooctane;

FIG. 9 provides breakthrough curves for MOF-5. DMDBT=4,6-dimethyldibenzothiophene; DBT=dibenzothiophene; BT=benzothiophene;

FIG. 10 provides breakthrough curves for 300 ppmw S dibenzothiophene in isooctane and in a toluene/isooctane mixture for MOF-5;

FIG. 11 demonstrates the regenerability of a packed bed of MOF-5 for the adsorption of (A) dibenzothiophene and (B) benzothiophene; and

FIG. 12 provides breakthrough curves for ultra-low sulfur diesel spiked to 300 ppmw S with dibenzothiophene.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. The description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application in their entirety to more fully describe the state of the art to which this invention pertains.

As used herein “linking ligand” means a chemical species (including neutral molecules and ions) that coordinate two or more metal atoms or metal clusters resulting in an increase in their separation, and the definition of void regions or channels in the framework that is produced. Examples include, but are not limited to, 4,4′-bipyridine (a neutral, multiple N-donor molecule) and benzene-1,4-dicarboxylate (a polycarboxylate anion).

As used herein, “coordinatively unsaturated metal centers” means a transition metal center that possesses fewer ligands than exist in the coordinatively saturated metal center. For example, the dinuclear copper paddlewheel in HKUST-1 lacking apical ligands has two coordinatively unsaturated metal centers.

In an exemplary embodiment of the present invention, a method for separating organosulfur compounds from a liquid is provided. The method of this embodiment comprises contacting the liquid with the microporous coordination polymer (MCP) to form a MCP-organosulfur inclusion compound. Examples of liquids that include organosulfur compounds include, but are not limited to, gasoline, diesel, and jet fuel. Specific examples of such compounds are alkyl thiols, aryl thiols, thioethers, thiocyanates, alkyl disulfides, aryl disulfides, thiophenes, benzothiophenes, and dibenzothiophenes.

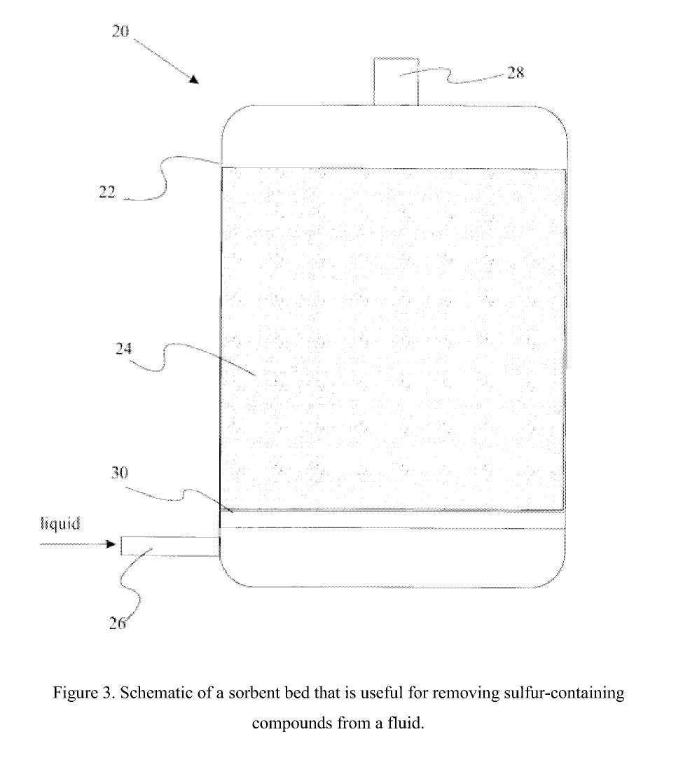

The liquid may be contacted with the MCP in any number of ways. For example, in one variation as shown in FIG. 3, a liquid is passed through sorbent bed 20. Sorbent bed 20 includes container 22, which contains microporous coordination polymer 24. The liquid is introduced into bed 20 via inlet port 26 and removed exit port 28. Spreader 30 assists in distributing the sulfur-containing liquid across the bed. In a refinement, the sorbent bed includes the microporous coordination polymer. In a further refinement, the sorbent bed is a mixed bed and/or a bed having more than one MCP. In a another refinement, the MCP has an overall anionic or cationic charge on the coordination polymer which is balanced by anionic or cationic species including but not limited to any group IB to VIIB cations, group IIIB and VIIB anions, any nitrate, nitrite, sulfate, thiosulfate, sulfite, perchlorate, chlorate, perchlorite, chlorite, phosphate, carbonate, acetate, formate, peroxide, oxalate, cyanide, cyanate, thiocyanate, amide, or hydroxide. In another refinement, the microporous coordination polymers having coordinatively unsaturated metal centers. In still another refinement, the MCP is impregnated with other metals, metal salts, organic compounds, and combinations thereof.

In another variation, a method for regeneration of the sorbent bed at a temperature lower than, equal to, or higher than sorption temperature is provided. The method of this variation comprises:
a) passing a fluid through the sorbent bed to remove adsorbed organosulfur compounds.
   In one refinement, the fluid is a liquid. In another refinement, the fluid is a gas. Such a gas can be a single component gas or a multicomponent gas such as air. In still another refinement, the sorption bed is regenerated by
a) passing a fluid through the sorbent bed to remove adsorbed organosulfur compounds; and
b) passing a gas through the sorbent bed to remove adsorbed organosulfur compounds.

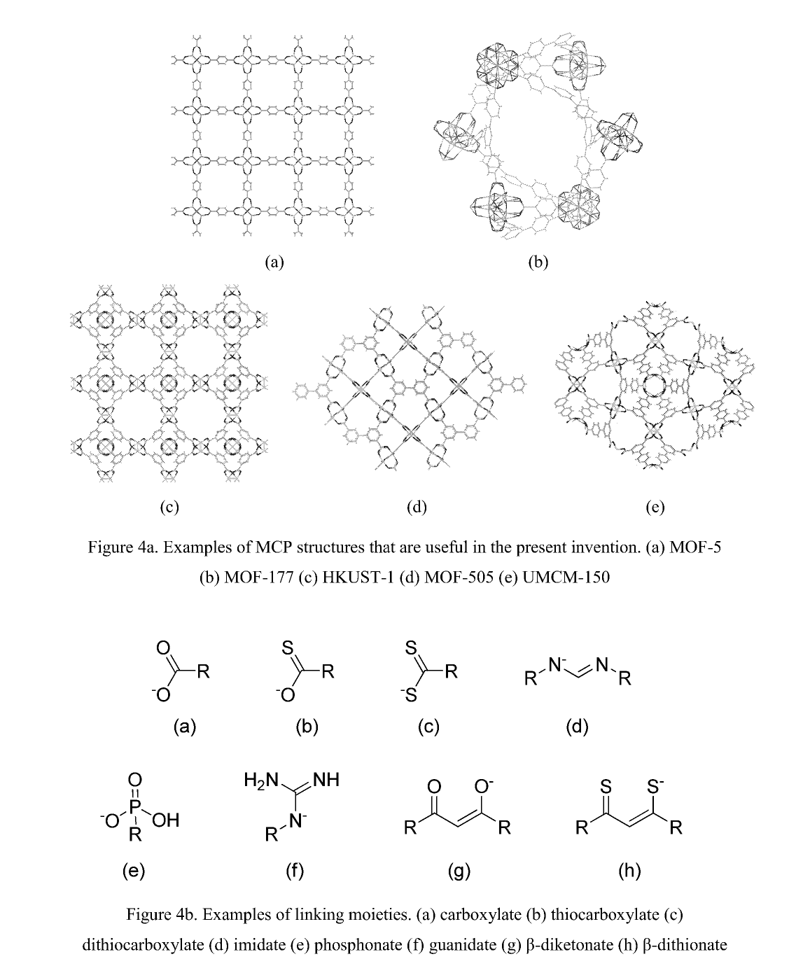

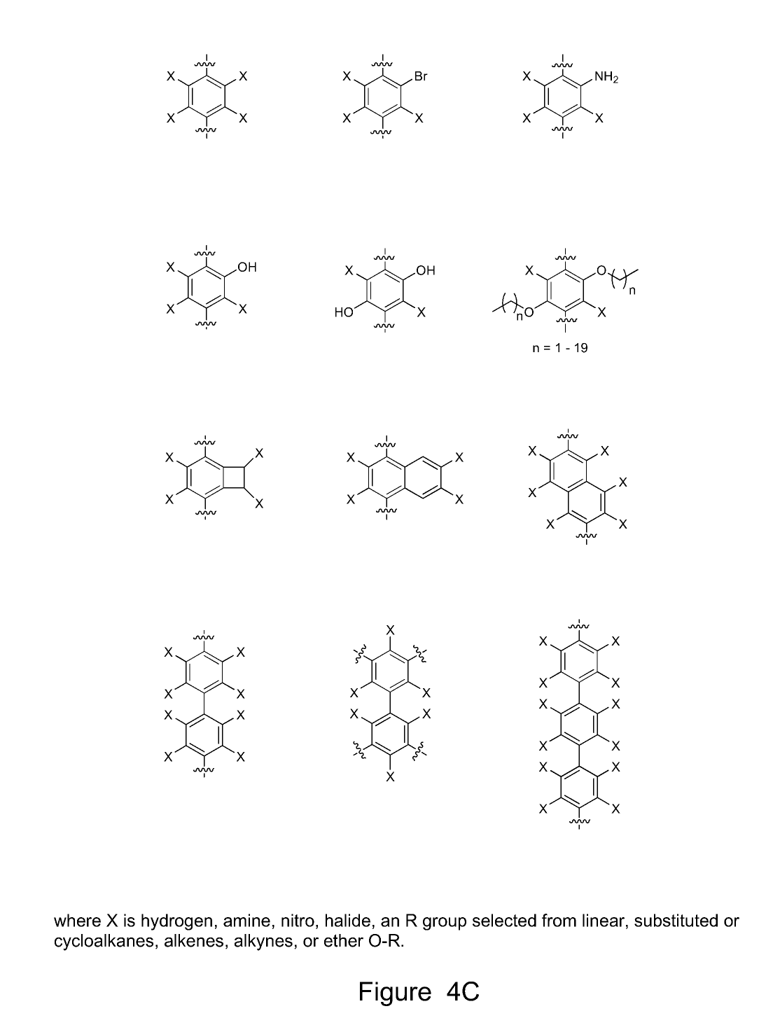

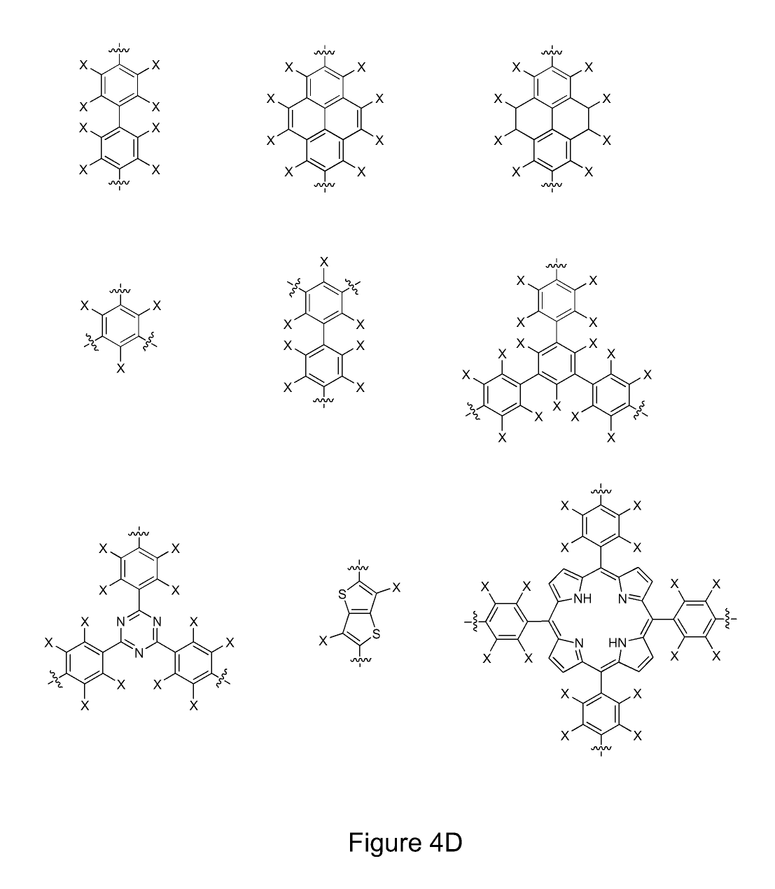

Any number of MCPs may be used in the methods of the invention. Examples of useful MCPs are found in U.S. Pat. Nos. 7,202,385; 7,196,210; 6,930,193; 6,929,679; and 5,648,508 and in U.S. Pat. Appl. Nos. 20070068389; 20060252641; 20060185388; 20060154807; 20050192175; and 20050154222. The entire disclosures of each of these patents and patent applications are hereby incorporated by reference. FIG. 4A provide structure of MCPs useful in variations of the present invention.

In one variation, the microporous coordination polymers are described by the following formula:

[R(L)ₙ]ₘ[Mₓ(μ-E)_{y}]

wherein:

M is a transition metal or rare earth metal from the group consisting of IA to VIIB;

μ-E is a bridging element from group IIIB to VIIB or a bridging ligand;

R is an organic spacer selected from a general group consisting of cyclic or acyclic organic compound (FIGS. 4C and 4D provides examples for R);

L is a linking moiety that attaches the metal to the organic group selected from a general group including carboxylate, thiocarboxylate, dithiocarboxylate, imidate, phosphonate, phosphoimidate, guanidate, β-diketonate, β-dithionate (FIG. 4B provides examples for L);

y is a number from 0 to 4;

n is a number less than or equal to 8. In a refinement, n is 1 to 8. In another refinement, n is 2 or 3;

m is the total charge of [Mₓ(μ-E)_{y}] divided by n. In a refinement, m is from 0 to 10. In a further refinement, m is from 4 to 6; and

x is the number of metals in [Mₓ(μ-E)_{y}]. In a refinement, x is 1 to 10.

The metal ions used in the microporous coordination polymers of the present invention comprise one or more metal ions. Useful metals are selected transition metals or rare earth metals from groups I to VIIB and of the periodic table. Specific examples of metal ions used include one or more ions selected from the group consisting Li⁺, Na⁺, K⁺, Rb⁺, Be²⁺, Mg²⁺, Ca²⁺, Sr²⁺, Ba²⁺, Sc³⁺, Y³⁺, Ti⁴⁺, Zr⁴⁺, Hf⁴⁺, V⁵⁺, V⁴⁺, V³⁺, V²⁺, Nb⁵⁺, Nb³⁺, Ta⁵⁺, Ta³⁺, Cr⁶⁺, Mo⁶⁺, Mo³⁺, W⁶⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh³⁺, Rh²⁺, Rh⁺, Ir³⁺, Ir⁺, Ni³⁺, Ni²⁺, Pd⁴⁺, Pd²⁺, Pt⁴⁺, Pt²⁺, Cu²⁺, Cu⁺, Ag⁺, Au³⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺, and combinations thereof.

Specific examples of bridging elements include O²⁻, OH⁻, N³⁻, NH²⁻, NH₂⁻, S²⁻, F⁻, Cl⁻, Br⁻, and I⁻.

The microporous coordination polymers may further include a metal cluster that includes one or more non-linking ligands. Useful non-linking ligands include, for example, a ligand selected from the group consisting of O²⁻, sulfate, nitrate, nitrite, sulfite, bisulfite, phosphate, hydrogen phosphate, dihydrogen phosphate, diphosphate, triphosphate, phosphite, chloride, chlorate, bromide, bromate, iodide, iodate, carbonate, bicarbonate, sulfide, hydrogen sulphate, selenide, selenate, hydrogen selenate, telluride, tellurate, hydrogen tellurate, nitride, phosphide, arsenide, arsenate, hydrogen arsenate, dihydrogen arsenate, antimonide, antimonate, hydrogen antimonate, dihydrogen antimonate, fluoride, boride, borate, hydrogen borate, perchlorate, chlorite, hypochlorite, perbromate, bromite, hypobromite, periodate, iodite, hypoiodite; and mixtures thereof.

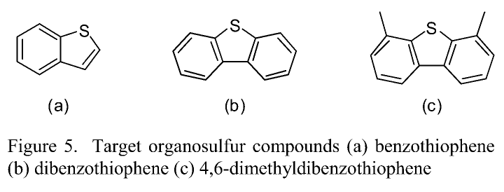

As set forth above, microporous coordination polymers are useful materials for the adsorption of organosulfur compounds because of the ability to tailor the linker and/or metal of an MCP for a specific application. This allows the removal of organosulfur species from fuels offering a route to produce low sulfur content diesel or other fuels. The organosulfur adsorption capacity of a variety of different MCPs from a model fuel (isooctane) containing benzothiophene (BT), dibenzothiophene (DBT), or 4,6-dimethyldibenzothiophene (DMDBT) (FIG. 5) has been measured using gas chromatography or UV-visible spectroscopy to monitor the change in concentration of the organosulfur compound. Results from the adsorption experiments, in g S adsorbed/kg MCP are shown in Table 1.

TABLE 1
Amount of adsorption of organosulfur compound to the MCP.

| | | | DMDBT |
|---|---|---|---|
| MCP | BT (g S/kg MCP) | DBT (g S/kg MCP) | (g S/kg MCP) |
| MOF-5 | 0* | 6 (at 268 ppm) | 10 (at 250 ppm) |
| IRMOF-3 | 1 (at 295 ppm) | 11 (at 250 ppm) | 12 (at 232 ppm) |
| IRMOF-9 | 4 (at 264 ppm) | 1 (at 290 ppm) | 1 (at 290 ppm) |
| IRMOF-20 | 0* | 4 (at 257 ppm) | 2 (at 278 ppm) |
| MOF-177 | 0* | 1 (at 292 ppm) | 1 (at 288 ppm) |
| MOF-74 | 0* | 0* | 0* |
| MOF-505 | 2 (at 296 ppm) | 43 (at 185 ppm) | 29 (at 151 ppm) |
| HKUST-1 | 2 (at 296 ppm) | 20 (at 142 ppm) | 4 (at 279 ppm) |
| UMCM-150 | 0* | 12 (at 259 ppm) | 30 (at 190 ppm) |
| MOF-14 | 5 (at 291 ppm) | 2 (at 284 ppm) | 1 (at 296 ppm) |

*at 300 ppm
BT = benzothiophene;
DBT = dibenzothiophene;
DMDBT = 4,6-dimethyldibenzothiophene.

In variations of the present invention, factors affecting the organosulfur compound adsorption for a given MCP include: the presence or absence of coordinatively unsaturated metal centers, the pore size and shape of the MCP, and the nature of the organic linker of the MCP. An MCP with coordinatively unsaturated metal centers may be able to better coordinate the organosulfur compounds through the sulfur atom or pi-system, allowing for high uptake of the compound. In a refinement of the invention, a MCP with an electron-deficient organic linker may be employed to achieve high organosulfur compound adsorption because of better charge transfer interaction of the linker with the electron-rich organosulfur compounds.

By changing the organic linker, the pore size and shape can be altered. As the length of the organic molecule used as a linker is increased, the pore size also increases. In some instances, however, when the pore size becomes too large there may be less interaction of the organosulfur compounds with the MCP, leading to a decrease in the adsorption of the organosulfur compound. It is necessary, therefore, to find a balance between a pore size that is too small for the organosulfur compounds to fit in and one where the pore is too big.

Comparison of the organosulfur compound adsorption of MCPs in Table 1 to MOF-5 shows several trends that support the usefulness of the present invention. IRMOF-9, which has smaller pores than MOF-5, has higher adsorption of benzothiophene, the smallest compound investigated, but shows very little adsorption of the larger compounds. On the other hand, IRMOF-20 and MOF-177 which both have larger pores than MOF-5, show less adsorption of the compounds due to less interaction of the organosulfur compounds with the structure.

IRMOF-3 shows a higher adsorption of both dibenzothiophene and 4,6-dimethyldibenzothiophene than MOF-5. The amino groups decorate the pores of the MCP apparently facilitating trapping of the compounds inside and leading to a higher adsorption for this MCP.

MOF-505, HKUST-1, and UMCM-150 exhibit a much higher capacity for dibenzothiophene and 4,6-dimethyldibenzothiophene than any of the other materials examined. These three MCPs are made up of copper metal clusters containing coordinatively unsaturated metal centers. Their high capacity suggests that coordinatively unsaturated metal centers play a favorable role in adsorption of these organosulfur compounds.

From the results, it can also be seen that by changing the MCP, selection for the removal of a desired organosulfur compound can be achieved. IRMOF-20 shows a higher affinity for dibenzothiophene over the other compounds, IRMOF-9 shows a higher affinity for benzothiophene over the other compounds, and MOF-5 shows a higher affinity for 4,6-dimethylbenzothiophene over the other compounds.

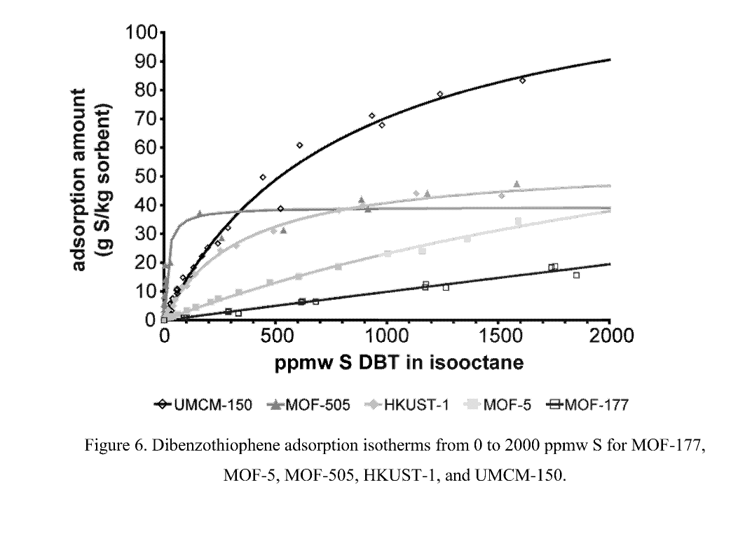

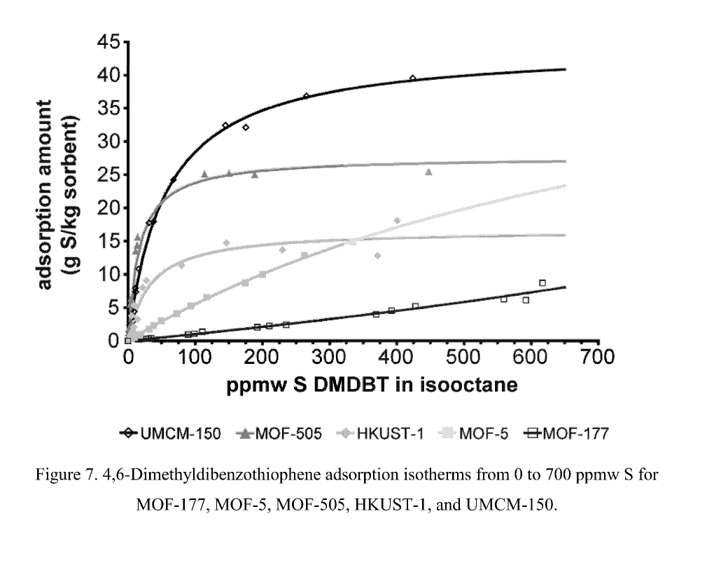

Full adsorption isotherms for dibenzothiophene have been measured for MOF-177, MOF-5, HKUST-1, MOF-505, and UMCM-150 for dibenzothiophene concentrations up to 2000 ppmw S. These are shown in FIG. 6. These materials exhibit high capacity up to very high sulfur concentrations. Adsorption isotherms have also been measured for the larger organosulfur compound, 4,6-dimethyldibenzothiophene, and are shown in FIG. 7.

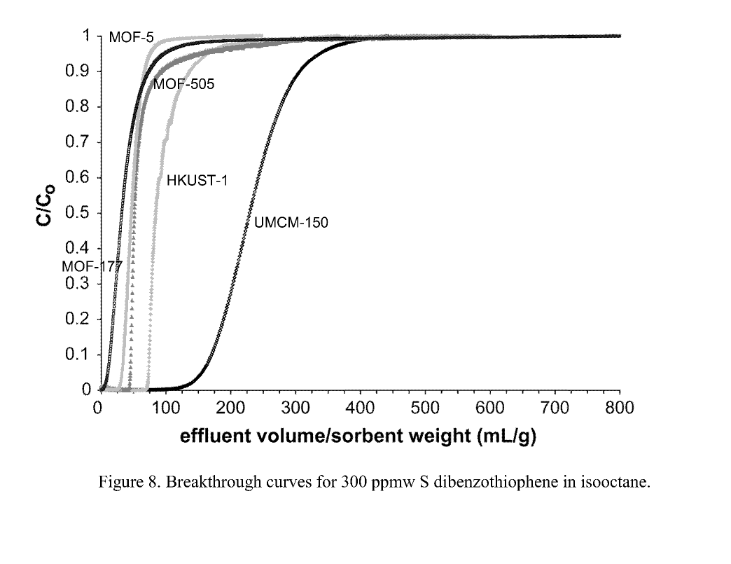

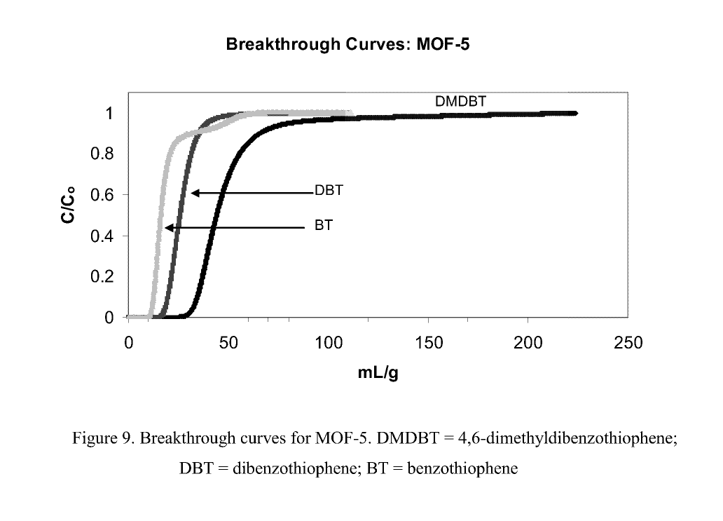

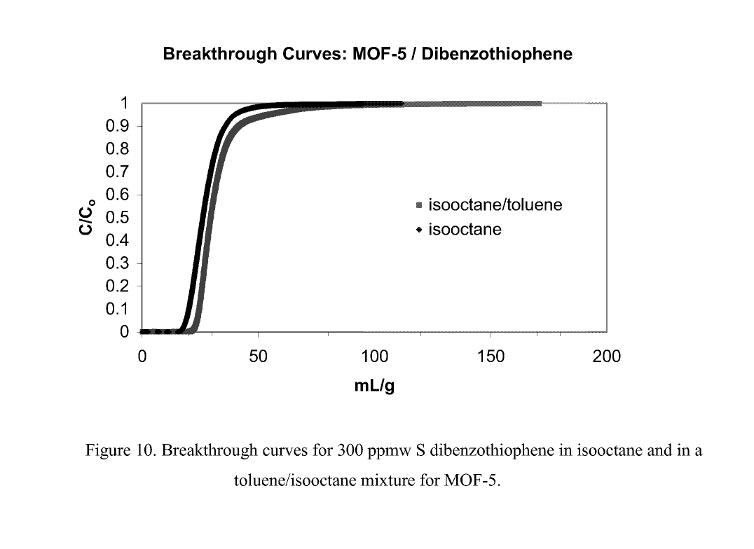

Packed bed breakthrough curves (FIG. 8) have been plotted for MOF-177, MOF-5, MOF-505, HKUST-1, and UMCM-150 for a model solution of 300 ppmw S dibenzothiophene in isooctane. The concentration of dibenzothiophene in the packed bed eluent was measured using a single wavelength UV-vis detector. Breakthrough curves were also plotted for MOF-5 for model solutions of 300 ppmw S benzothiophene, dibenzothiophene, and 4,6-dimethyldibenzothiophene in isooctane (FIG. 9). Since diesel fuel contains a large amount of aromatic compounds, a model solution of 300 ppmw S dibenzothiophene in 10% toluene and 90% isooctane (by volume) was tested using MOF-5 as the sorbent (FIG. 10). The addition of toluene to the solution has no effect on the ability of the material to desulfurize the solution.

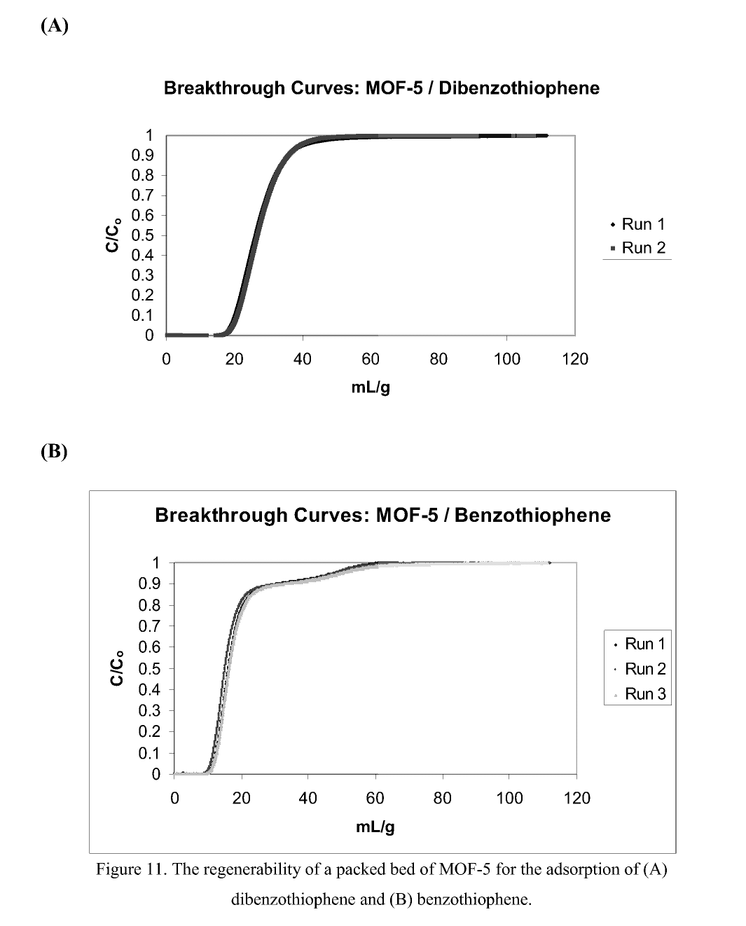

The regenerability of MOF-5 was tested by running pure isooctane through the packed bed to desorb the organosulfur compound. A new breakthrough curve was then plotted. As can be seen in FIG. 11, MOF-5 is regenerable for benzothiophene and dibenzothiophene.

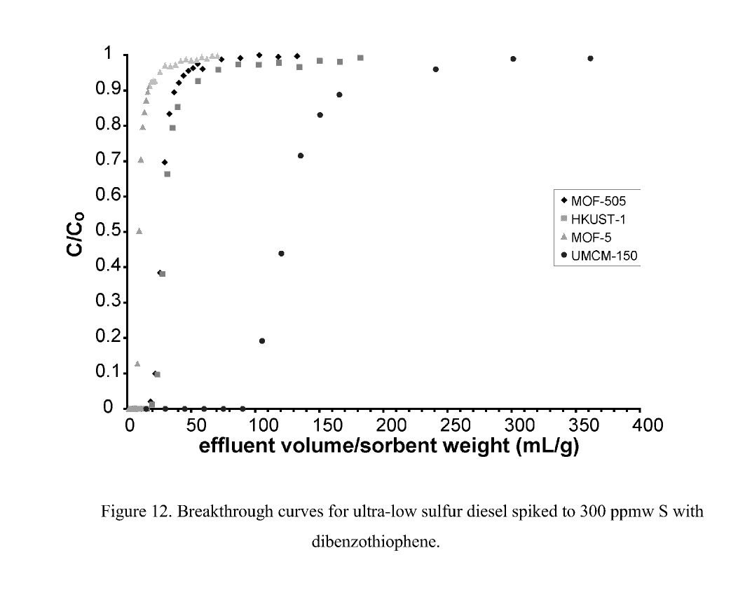

To test these materials one step further, a solution of ultra-low sulfur diesel (<15 ppmw S according to Department of Transportation standards) was spiked to approximately 300 ppmw S with dibenzothiophene and used to plot breakthrough curves of MOF-5, MOF-505, HKUST-1, and UMCM-150 (FIG. 12). In this case, the eluent was monitored using a gas chromatograph equipped with a flame photometric detector to detect the presence of sulfur in the sample. Earlier breakthrough than in the experiments with dibenzothiophene in isooctane as a model solution is observed due to the presence of competing adsorption with the aromatic compounds found in diesel samples, although for example, in UMCM-150 a significant amount of fuel is desulfurized before the breakthrough point.

While embodiments of the invention have been illustrated and described, it is not intended that these embodiments illustrate and describe all possible forms of the invention. Rather, the words used in the specification are words for description rather than limitation, and it is understood that various changes may be made without departing from the spirit and scope of the invention.

What is claimed is:

1. A method for separating organosulfur compounds from a liquid, the method comprising:
contacting the liquid with a microporous coordination polymer to form a MCP-organosulfur inclusion compound.

2. The method of claim 1 wherein the liquid is gasoline, diesel, or jet fuel.

3. The method of claim 1 wherein the organosulfur compound is selected from the group consisting of alkyl thiols, aryl thiols, thioethers, thiocyanates, alkyl disulfides, aryl disulfides, thiophenes, benzothiophenes, and dibenzothiophenes.

4. The method of claim 3 wherein the organosulfur compound is selected from the group consisting of benzothiophene (BT), dibenzothiophene (DBT), or 4,6-dimethyldibenzothiophene (DMDBT)

5. The method of claim 1 wherein the liquid is passed through a sorbent bed comprising a microporous coordination polymer.

6. The method of claim 1 wherein the microporous coordination polymer has an overall anionic or cationic charge on the coordination polymer which is balanced by anionic or cationic species including but not limited to any group IA to VIIB cations, group IIIB to VIIB anions, any nitrate, nitrite, sulfate, thiosulfate, sulfite, perchlorate, chlorate, perchlorite, chlorite, phosphate, carbonate, acetate, formate, peroxide, oxalate, cyanide, cyanate, thiocyanate, amide, or hydroxide.

7. The method of claim 1 wherein the microporous coordination polymers have coordinatively unsaturated metal centers.

8. The method of claim 1 wherein the microporous coordination polymer is impregnated with a component selected from the group consisting of metals, metal salts, organic compounds, and combinations thereof.

9. The method of claim 5 wherein the sorbent bed is a mixed bed and/or a bed having more than one microporous coordination polymer.

10. The method of claim 1 wherein the microporous coordination polymers are described by the following formula:
[R(L)ₙ]ₘ[Mₓ(μ-E)_{y}]
wherein:
M is a transition metal or rare earth metal from the group consisting of IA to VIIB;
μ-E is a bridging element from group IIIB to VIB;
R is an organic spacer selected from a general group consisting of cyclic or acyclic organic compounds;
L is a linking moiety;
y is a number from 0 to 4;
n is a number less than or equal to 8;
m is the total charge of [Mₓ(μ-E)_{y}] divided by n; and
x is the number of metals in [Mₓ(μ-E)_{y}].

11. The method of claim 10 wherein the linking ligand attaches to the transition metal through an organic group selected from a general group including carboxylate, thiocarboxylate, dithiocarboxylate, imidate, phosphonate, phosphoimidate, guanidate, β-diketonate, β-dithionate;

12. A method for regeneration of a sorbent bed, the method comprising:
a) passing a fluid through the sorbent bed to remove adsorbed organosulfur compounds.

13. The method of claim 12 wherein the fluid comprises a component selected from the group consisting of liquids, gases and combinations thereof.

14. The method of claim 12 wherein regeneration is performed at a temperature lower than the sorption temperature.

15. The method of claim 12 wherein regeneration is performed at a temperature greater than or equal to the sorption temperature.

16. The method of claim 12 wherein the sorption bed is regenerated by
a) passing a fluid through the sorbent bed to remove adsorbed organosulfur compounds; and
b) passing a gas through the sorbent bed to remove adsorbed organosulfur compounds.
